(19) United States
(12) Patent Application Publication
(10) Pub. No.: US 2025/0371257 A1
(43) Pub. Date: Dec. 4, 2025

(54) METHOD, DEVICE, MEDIUM AND PROGRAM PRODUCT FOR INFORMATION INTERACTION

(71) Applicant: Beijing Youzhuju Network Technology Co., Ltd., Beijing (CN)

(72) Inventor: Li Jia, Beijing (CN)

(21) Appl. No.: 19/220,424

(22) Filed: May 28, 2025

(30) Foreign Application Priority Data
May 28, 2024 (CN) 202410675085.7

(51) Int. Cl. G06F 40/174; G06F 40/186

(52) U.S. Cl. CPC G06F 40/174; G06F 40/186

(57) ABSTRACT

According to embodiments of the disclosure, a method, a device, a medium and a program product for information interaction are provided. The method includes: generating a first prompt input for each of at least one machine learning model, the first prompt input being configured to guide a corresponding machine learning model to generate a service information entry requirement corresponding to a target service type; obtaining output of the at least one machine learning model by providing the first prompt input to the corresponding machine learning model; and determining a service information entry page corresponding to the target service type based on the output of the at least one machine learning model, the service information entry page at least indicating a plurality of information entry items.

### CROSS-REFERENCE

The present application claims priority to Chinese Patent Application No. 202410675085.7, filed on May 28, 2024 and entitled “METHOD, DEVICE, MEDIUM AND PROGRAM PRODUCT FOR INFORMATION INTERACTION”, the entirety of which is incorporated herein by reference.

### FIELD

Example embodiments of the present disclosure generally relate to the field of computer technologies, and in particular, to a method, apparatus, device, and computer-readable storage medium for information interaction.

### BACKGROUND

The Internet offers access to a wide variety of resources. For example, various applications, commodities, audio and video contents, and the like may be accessed through the Internet. In addition, content delivery and service promotion through the Internet become a new form of information propagation and have been widely applied. A recommendation system (e.g., an advertisement system) supports generating a service information entry page based on a configuration of a content provider and receiving service information provided by a service provider (e.g., an advertiser) via a service information entry page. The recommendation system may, for example, generate recommendation contents (e.g., advertisements) based on the received service information and provide the recommendation content to the user. SUMMARY

In a first aspect of the present disclosure, a method for information interaction is provided. The method comprises: generating a first prompt input for each of at least one machine learning model, the first prompt input being configured to guide a corresponding machine learning model to generate a service information entry requirement corresponding to a target service type; obtaining output of the at least one machine learning model by providing the first prompt input to the corresponding machine learning model; and determining a service information entry page corresponding to the target service type based on the output of the at least one machine learning model, the service information entry page at least indicating a plurality of information entry items.

In a second aspect of the present disclosure, an apparatus for information interaction is provided. The apparatus comprises: a prompt generation module configured to generate the first prompt input for each of at least one machine learning model, the first prompt input being configured to guide the corresponding machine learning model to generate the service information entry requirement corresponding to the target service type; an output obtaining module configured to output of the at least one machine learning model by providing the first prompt input to the corresponding machine learning model; and a page determination module configured to determine the service information entry page corresponding to the target service type based on the output of the at least one machine learning model, the service information entry page at least indicating a plurality of information entry items.

In a third aspect of the present disclosure, an electronic device is provided. The electronic device comprises: at least one processing unit; and at least one memory, coupled to the at least one processing unit and storing instructions for execution by the at least one processing unit, the instructions, when executed by the at least one processing unit, causing the electronic device to perform the method of the first aspect of the present disclosure.

In a fourth aspect of the present disclosure, there is provided a computer-readable storage medium, storing thereon a computer program executable by a processor to implement the method of the first aspect of the present disclosure.

According to a fifth aspect of the present disclosure, there is provided a computer program product, comprising a computer program, wherein the computer program, when executed by a processor, implements the method according to the first aspect of the present disclosure.

It should be understood that the content described in this section is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates a flowchart of a method for information interaction according to some embodiments of the present disclosure;

FIG. 3 illustrates a schematic diagram of an example of a first prompt input according to some embodiments of the present disclosure;

FIG. 4 illustrates a schematic diagram of an example of generating code according to some embodiments of the present disclosure;

FIG. 5 illustrates a schematic diagram of an example of a service information entry page according to some embodiments of the present disclosure;

FIG. 6 illustrates a schematic diagram of an example according to some embodiments of the present disclosure;

FIGS. 7A and 7B are partial views together illustrating a schematic diagram of an example of information interaction according to some embodiments of the present disclosure;

FIG. 8 illustrates a schematic structural block diagram of an apparatus for information interaction according to some embodiments of the present disclosure; and

FIG. 9 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “comprise” and the like should be understood to comprise “comprise but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be comprised below.

Herein, unless explicitly stated, performing one step “in response to A” does not imply that this step is performed immediately after “A”, but may comprise one or more intermediate steps.

It may be understood that the data involved in the technical solution (comprising but not limited to the data itself, the obtaining or use of the data) should follow the requirements of the corresponding laws and regulations and related regulations.

It can be understood that, before the technical solutions disclosed in the embodiments of the present disclosure are used, the types, the usage scope, the usage scenario and the like of personal information related to the present disclosure should be notified to the user in an appropriate manner according to the relevant laws and regulations, and the authorization of the user should be obtained.

For example, in response to receiving an active request from a user, prompt information is sent to the user to explicitly prompt the user that the requested operation will require the acquisition and use of the personal information of the user. Thereby, the user can autonomously select whether to provide personal information to software or hardware (such as an electronic device, an application program, a server, or a storage medium) executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in text in the pop-up window. In addition, the pop-up window may further carry a selection control for the user to select “agree” or “disagree” to provide personal information to the electronic device.

It may be understood that the foregoing notification and user authorization acquisition process are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data, such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically comprise an input layer and an output layer and one or more hidden layers between the input layer and the output layer. The neural network used in deep learning applications typically comprise many hidden layers, thereby the depth of the network is increased. Each layer of the neural network is connected in sequence, such that the output of the previous layer is provided as an input to the next layer, wherein the input layer receives the input of the neural network and the output of the output layer serves as the final output of the neural network. Each layer of the neural network comprises one or more nodes (also referred to as processing nodes or neurons), and each node processing the input from the previous layer.

Generally, the machine learning may generally comprise three phases: a training phase, a testing phase, and an application phase (also referred to as an inference phase). At the training stage, a given model may be trained using a large amount of training data, constantly update the parameter values, until the model is able to obtain consistent inferences from the training data that satisfy the expected objectives. By training, the model may be considered to be able to learn an association from input to output (also referred to as mapping from input to output) from the training data. The parameter values of the trained model are determined. At the testing phase, the test input is applied to the trained model to test whether the model can provide the correct output, thereby determining the performance of the model. The testing phase may sometimes be merged in a training phase. At the application or inference stage, the trained model may be used to process the actual model input based on the parameter value obtained by training, to determine a corresponding model output.

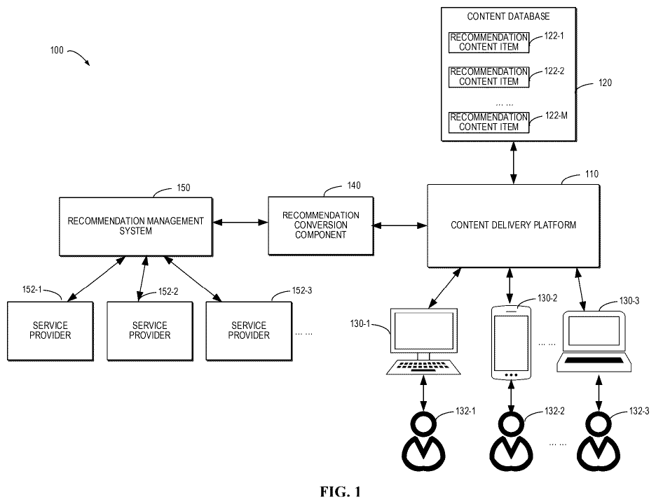

FIG. 1 illustrates a schematic diagram of an example environment 100 in which embodiments of the present disclosure can be implemented. One or more content providers may use the recommendation management system 150 to manage the content to be on the content delivery platform 110. One or more client devices 130-1, 130-2, 130-3, etc. (collectively or individually referred to as the client device 130 for ease of discussion) are associated with the content delivery platform 110, and may access various content provided on the content delivery platform 110, for example, based on respective users 132-1, 132-2, 132-3, etc. (collectively or individually referred to as the user 132 for ease of discussion). As an example, the content delivery platform 110 may be an application, a website, a web page, and other accessible platform. The client device 130 may be installed with an application for accessing the content delivery platform 110, or may access the content delivery platform 110 in a suitable manner.

The content delivery platform 110 may be configured to deliver one or more particular recommendation content items (e.g., provided or presented at the client device 130) related to the one or more services to the user population based on the respective policies. The recommendation content items to be delivered may comprise, for example, one or more recommendation content items 122-1, 122-2, . . . 122-M (collectively or individually referred to as the recommendation content item 122 for ease of discussion) in the content database 120.

Herein, a service may comprise, for example, various recommendable objects, examples of which may comprise applications, physical commodities/services, virtual commodities/services, digital content/entity content, and the like. Herein, the “recommendation content item” refers to content that is presented in order to recommend a corresponding service. Examples of recommendation content items may comprise advertisements. Herein, the user population may comprise one or more user members, such as the user 132. The user member may be any potential consumer of a service, such as a user, group, organization, entity, or the like.

In some embodiments, the content delivery platform 110 may distribute corresponding recommendation content items 122 to the user 130 based on requests by the service provider 152-1, 152-2, 152-3, etc. (collectively or individually referred to as the “service provider” 152). In the scenario of advertisement delivery, a service provider is sometimes also referred to as an advertiser. In some embodiments, the recommendation content item for presentation to a specific client device 130 in a content presentation opportunity (e.g., at a specific time and a specific location) on the content delivery platform 110 may be selected based on the bid results. For example, a bid from the service provider may be received and the content presentation opportunity may be allocated to the highest bidder, meaning that the corresponding recommendation content item may be successfully delivered in the competitive delivery. Bid may refer to a cost to spend on competitively delivering a certain recommendation content item in a certain content presentation opportunity.

In some embodiments, the service provider 152 may also pay for providers of the content delivery platform 110 based on the presentation of the recommendation content item and a subsequent conversion, among others. The recommendation conversion component 140 is configured to collect a conversion result of the user 132 for the recommendation content item. The conversion result for the recommendation content item may comprise viewing, clicking, downloading, paying, adding to shopping cart, and the like for the recommendation content item, and the specific conversion behavior is related to the recommended service and the service provider.

In some embodiments, the recommendation content item 122 may relate to a form capable of collecting information. Such recommendation content items are sometimes also referred to as form advertisements. In this way, form information collecting can be performed in the platform by presenting the form. The form advertisement may be used to invite the user to subscribe to the service, provide service valuation, answer follow-up service introduction, and receive information of the service provider, etc. The form submission, that is, collecting information through a form, may also be determined by the recommendation conversion component 140 as a conversion result of the recommendation content item.

In environment 100, the recommendation management system 150 may be configured to deliver the recommendation content item related to the form. In some embodiments, the form information collected through the delivered form may be stored. The recommendation management system 150 may provide the collected form information to the information demander based on the information request of the service provider 152. In some embodiments, the service provider may also comprise a service supplier requesting to deliver the recommendation content item, or may be another information demander.

In some embodiments, the recommendation management system 150 may further provide the service provider 152a with a service information entry page for receiving service information, and receive the service information provided by the service provider 152 via the service information entry page. The recommendation management system 150 may determine, for example, the recommendation content item to be delivered based on the service information.

In environment 100, the client device 130 may be any type of mobile terminal, fixed terminal, or portable terminal, comprising a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, comprising accessories and peripherals of these devices, or any combination thereof. In some embodiments, the client device 130 can also support any type of interface for a user (such as a “wearable” circuit, etc.).

In environment 100, the content delivery platform 110, the recommendation conversion component 140, and/or the recommendation management system 150 may be, for example, various types of computing systems/servers capable of providing computing power, comprising, but not limited to, mainframes, edge computing nodes, computing devices in a cloud environment, and so forth. Although illustrated separately, one or more of the content delivery platform 110, the recommendation conversion component 140, and/or the recommendation management system 150 may be combined.

It should be understood that the components and arrangements in the environment shown in FIG. 1 are merely examples, and that the computing system suitable for implementing the example embodiments described in this disclosure may comprise one or more different components, other components, and/or different arrangements.

Traditionally, the service information entry page is often designed manually. Since the service types provided by different service providers may be different, for higher reception service information, different service information entry pages need to be provided for different service types. It requires a lot of manpower, making the entire page maintenance and update process complex and costly.

According to embodiments of the present disclosure, an improved solution for information interaction is provided. According to the solution, a first prompt input for each of at least one machine learning model is generated, wherein the first prompt input is configured to guide a corresponding machine learning model to generate a service information entry requirement corresponding to a target service type. The output of the at least one machine learning model is obtained by providing the first prompt input to the corresponding machine learning model. A service information entry page corresponding to the target service type is determined based on the output of the at least one machine learning model, wherein the service information entry page at least indicates a plurality of information entry items.

In this way, with the model capability, the service information structured definition of each type can be quickly completed with higher efficiency, the manpower and time cost in the service information structured definition stage is reduced, and more accurate and expected service information structures can be obtained for improving the user experience and service recommendation efficiency of the client.

Some example embodiments of the present disclosure will be described below with continued reference to the accompanying drawings.

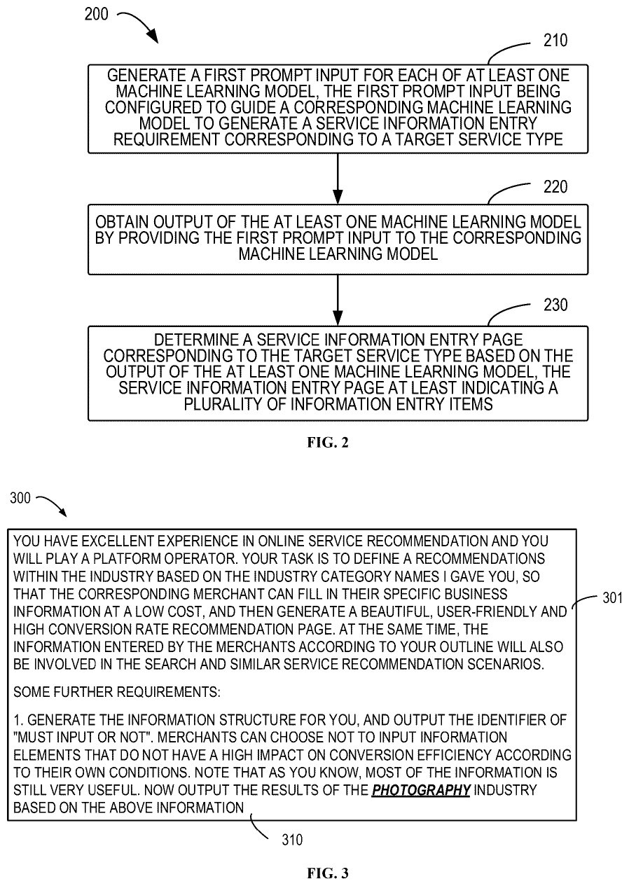

FIG. 2 shows a flowchart of a method 200 for information interaction according to some embodiments of the present disclosure. For ease of discussion, the method 200 is described with reference to FIG. 1. Note that the discussion is made in connection with the recommendation management system 150 only for purposes of discussion, it should be understood that embodiments of the present disclosure may be implemented in any suitable device or system.

At block 210, the recommendation management system 150 generates a first prompt input for each of the at least one machine learning model, where the first prompt input is configured to guide a corresponding machine learning model to generate a service information entry requirement corresponding to a target service type. The types herein may be divided based on characteristics of the offered services according to any suitable criteria. For example, different types may be divided by the industry to which the service belongs, or the types of service may be divided at a larger or smaller granularity.

The machine learning model used herein may be any suitable trained machine learning model, which may be based on any suitable model structure comprising, but not limited to, any suitable model such as a Transformer model, a convolutional neural network (CNN), a recurrent neural network (RNN), a deep neural network (DNN), or the like. In some embodiments, the machine learning model may be a language model (LM). If the at least one machine learning model comprises a plurality of machine learning models, the plurality of machine learning models may be the same, may be partially different, or may be completely different. The machine learning model used is a content generative model capable of generating corresponding outputs based on model inputs. In some embodiments, the language model-based machine learning model is capable of receiving model inputs in natural language and/or machine language, and is capable of generating a desired output according to the indication of the input and the prompt.

The first prompt input is configured to guide a corresponding machine learning model to generate a service information entry requirement corresponding to a target service type, or is referred to as a service information template or a service information structure. According to such service information entry requirement, each service provider to recommend a service may provide various required service information for generating recommendation content items (e.g., advertisements) for the service for delivery on the content delivery platform. The first prompt input may comprise at least an indication or description of the target service type, a generation criterion for the service information entry requirement (comprising service information to be collected, a purpose of the collected service information, and a desired effect, etc.), a method for using the model input information, and the like. Through such a prompt input, the machine learning model can better learn the user requirements, thereby generating more expectable entry requirements of the service information.

In some embodiments, the recommendation management system 150 may obtain a prompt template for each of the at least one machine learning model. If the at least one machine learning model comprises a plurality of machine learning models, such a plurality of machine learning models may correspond to different prompt templates, or may correspond to a same prompt template. For example, the recommendation management system 150 may fill the indication of the target service type into the prompt template to obtain the first prompt input.

The indication of the target service type may comprise, for example, text describing the target service type (e.g., text “photography”, which may indicate that the target service type is a photography type). The recommendation management system 150 may, for example, receive the user input via an input box, and determine text for describing the target service type based on the user input. The indication of the target service type may also comprise, for example, an option corresponding to the target service type. The recommendation management system 150 may also, for example, present multiple options corresponding to multiple service types. In response to a reception of a selection operation for a certain option, the recommendation management system 150 may determine the option as an option corresponding to the target service type.

Reference is made to FIG. 3, which is a schematic diagram of an example 300 of a first prompt input according to some embodiments of the present disclosure. The recommendation management system 150 may, for example, fill the prompt template 301 with the indication 310 (e.g., text “photography”) of the target service type to obtain the example 300.

In some embodiments, the recommendation management system 150 may also generate a first prompt input directly based on the received user input. The user input comprises at least text for describing the target service type. For example, the recommendation management system 150 may receive a user input comprising the text “please generating XXXXXXX of photography industry based on XXXXX”, wherein the “photography industry” indicates the target service type. The recommendation management system 150 may generate the first prompt input directly based on the user input. It may be understood that the recommendation management system 150 may further generate the first prompt input by using any other suitable method, and the present disclosure does not limit the specific method for generating the first prompt input.

At block 220, the recommendation management system 150 obtains the output of the at least one machine learning model by providing the first prompt input to the corresponding machine learning model. It may be understood that the output of the at least one machine learning model may indicate a service information entry requirement corresponding to the target service type.

The machine learning model may be a model deployed at the recommendation management system 150, or may be a model deployed at other systems/devices. If the machine learning model is a model deployed at other systems/devices, the recommendation management system 150 may process the first prompt input using a machine learning model deployed at other systems/devices through a communication connection with other systems/devices. The recommendation management system 150 may provide the first prompt input to the machine learning model. After obtaining the first prompt input, the machine learning model may generate an output for the first prompt input. The recommendation management system 150 may in turn obtain the output of the machine learning model from the machine learning model. It may be understood that the recommendation management system 150 may separately provide the at least one first prompt input to the at least one machine management model to obtain output of the at least one machine learning model.

The output of the at least one machine learning model may, for example, indicate at least one information type corresponding to the target service type. Taking the target service type as a photography type as an example, the corresponding at least one information type may comprise, for example, a company brief introduction, a service item, a photographic work, a photographer introduction, reservation information, and photographic common question and answer. The output of the at least one machine learning model may also indicate, for example, at least one candidate information entry item of each information type. For example, if the output comprises the information type of the service item, the at least one candidate information entry item may comprise a photographing price, a photographing content, a photographing location, a photographing time, a photographing style, and the like. The output of the at least one machine learning model may also indicate, for example, an entry optionality of a respective candidate information entry item. The entry optionality may indicate whether the corresponding candidate information entry item must be entered or not must be entered. For example, for the information type of the service item, the photographing price, the photographing content, and the photographing location may be the entry items that must be entered, and the photographing time and the photographing style may be entries that not must be entered. The output of the at least one machine learning model may also indicate an entry mode of a respective candidate information entry item, for example. The entry mode may comprise receiving user input via an input box, providing an option to receive an option operation for the option (comprising a single or multiple selection), and/or the like.

At block 230, the recommendation management system 150 determines the service information entry page corresponding to the target service type based on the output of the at least one machine learning model, wherein the service information entry page at least indicates a plurality of information entry items.

In some embodiments, if the at least one machine learning model comprises a plurality of machine learning models, the recommendation management system 150 may deduplicate the outputs of the plurality of machine learning models, and determine a target service information entry requirement corresponding to the target service type based on the deduplicated outputs of the plurality of machine learning models. It may be understood that the recommendation management system 150 may deduplicate the outputs of the plurality of machine learning models in any suitable manner. For example, the recommendation management system 150 may deduplicate the outputs of the plurality of machine learning models based on any suitable rules or algorithms. The recommendation management system 150 may further determine, based on the target service information entry requirement, a service information entry page corresponding to the target service type.

In some embodiments, the recommendation management system 150 may further present the output of the at least one machine learning model to the user. The recommendation management system 150 may, for example, present an interaction page, receive the user input via the interaction page, and present output of the at least one machine learning model to the user. For example, the recommendation management system 150 may determine, based on the received adjustment of the output of the at least one machine learning model from the user, the target service information entry requirement corresponding to the target service type. For example, the recommendation management system 150 may present the output of the at least one machine learning model in text form in the interaction page, and may receive, via the interaction page, an adjustment of the text (e.g., add/delete/modify text) corresponding to the output by the user. For example, the recommendation management system 150 may determine the target service information entry requirement based on the adjusted text. The recommendation management system 150 may determine, based on the target service information entry requirement, a service information entry page corresponding to the target service type.

In some embodiments, the output of the at least one machine learning model is represented in natural language. The natural language herein may be any suitable language. For example, the recommendation management system 150 may determine the target service information entry requirement corresponding to the target service type based on the output of the at least one machine learning model, and generate code corresponding to the machine language based on the target service information entry requirement. The machine language may also comprise any suitable machine language, such as a machine language of a JSON format.

Regarding the specific manner of generating the code, in some embodiments, the recommendation management system 150 may directly determine the target service information entry requirement, and generate the code based on the target service information entry requirement. For example, the recommendation management system 150 may present a code generation control in association with the output of the at least one machine learning model/deduplicated output of the plurality of machine learning models/adjusted output of the at least one machine learning model. For example, in response to a reception of the trigger operation on the code generation control, the recommendation management system 150 may directly determine the target service information entry requirement based on the output of the at least one machine learning model/the deduplicated output of the at least one machine learning model/adjusted output of the at least one machine learning model, and generate the code based on the target service information entry requirement.

In some embodiments, the recommendation management system 150 may further generate a second prompt input for the at least one machine learning model based on the target service information entry requirement. The second prompt input is configured to guide the at least one machine learning model to generate the code corresponding to the machine language based on the target service information entry requirement. Similar to the generation of the first prompt input, the recommendation management system 150 may obtain a prompt template for each of the at least one machine learning model, and obtain the second prompt input based on the target service information entry requirement and the prompt template. For example, the recommendation management system 150 may fill the prompt template with the target service information entry requirement to obtain the second prompt input.

Alternatively or additionally, in some embodiments, the recommendation management system 150 may also receive the user input via the input box, and directly determine the received user input as the second prompt input. The present disclosure does not limit the specific manner of generating the second prompt input. It may be understood that the at least one machine learning model that receives the first prompt input and the at least one machine learning model that receives the second prompt input may be the same, may be partially different, or may be completely different. After obtaining the second prompt, the recommendation management system 150 may obtain the code outputted by the at least one machine learning model by inputting the second prompt into the at least one machine learning model. Based on the output of the natural language model, the model may be further used to automatically generate the code, thereby further improving the generation efficiency of the service information entry page.

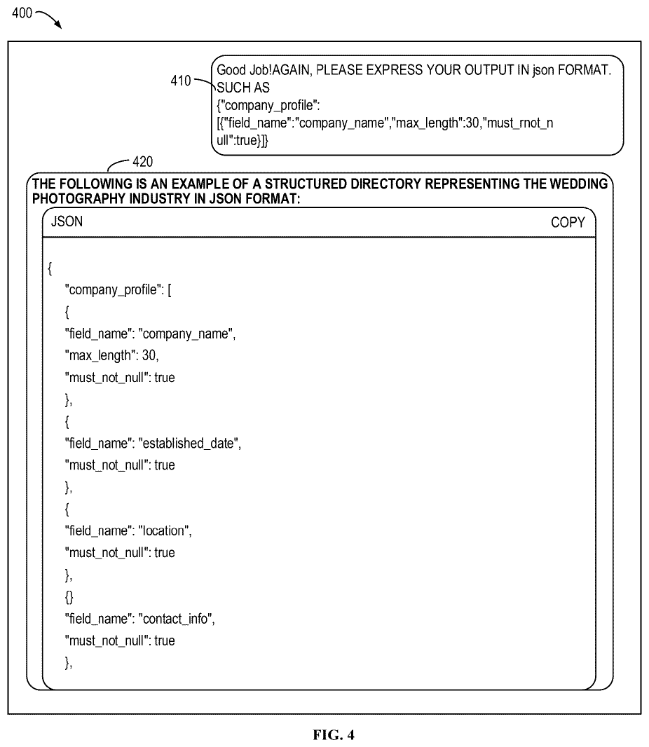

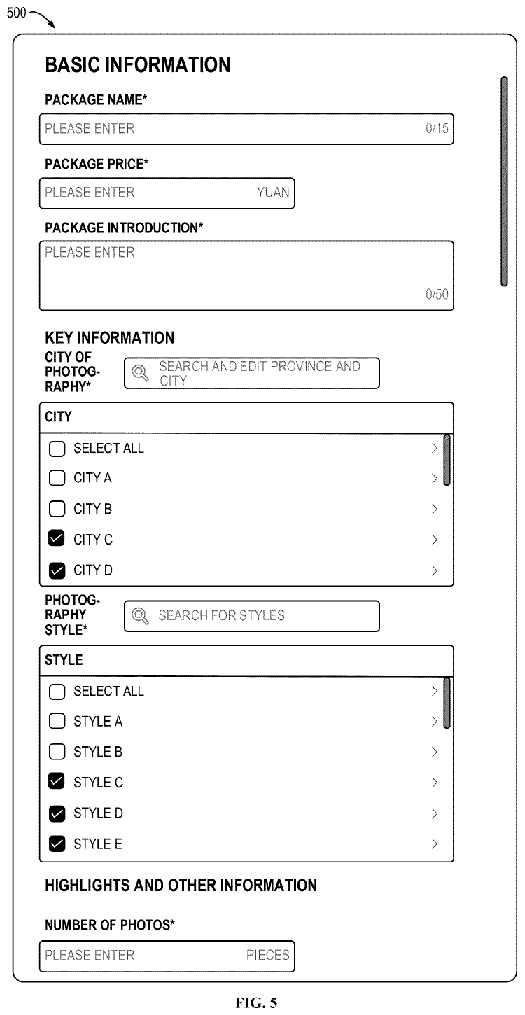

Referring to FIG. 4, FIG. 4 is a schematic diagram of an example 400 of generating code according to some embodiments of the present disclosure. As shown in FIG. 4, the recommendation management system 150 may receive the user input 410, and determine the user input 410 as a second prompt input. The recommendation management system 150 may provide the second prompt input to the at least one machine learning model to obtain the code 420 outputted by the at least one machine learning model.

Further, the recommendation management system 150 may generate the service information entry page corresponding to the target service type based on the code. In some embodiments, the recommendation management system 150 may further generate a service information entry page corresponding to the target service type based on the received adjustment to the code 520 and based on the adjusted code.

It should be understood that, in some embodiments, the service information entry requirement corresponding to the target service type may also be obtained through interaction with the machine learning model, and then the service information entry page is generated in a non-model manner.

Referring to FIG. 5, FIG. 5 is a schematic diagram of an example 500 of a service information entry page according to some embodiments of the present disclosure. As shown in FIG. 5, the example 500 may, for example, be a service information entry page corresponding to a photography service. Example 500 may comprise a package name, a package price, a package introduction, a city of photography, a photography style, a number of photos, and other information entry items. The information entry items indicate which types of service information need to be provided by the service provider when the service information corresponding to the photography service industry is entered for service recommendation. It will be appreciated that example 500 may also comprise more, fewer, or different information entry items.

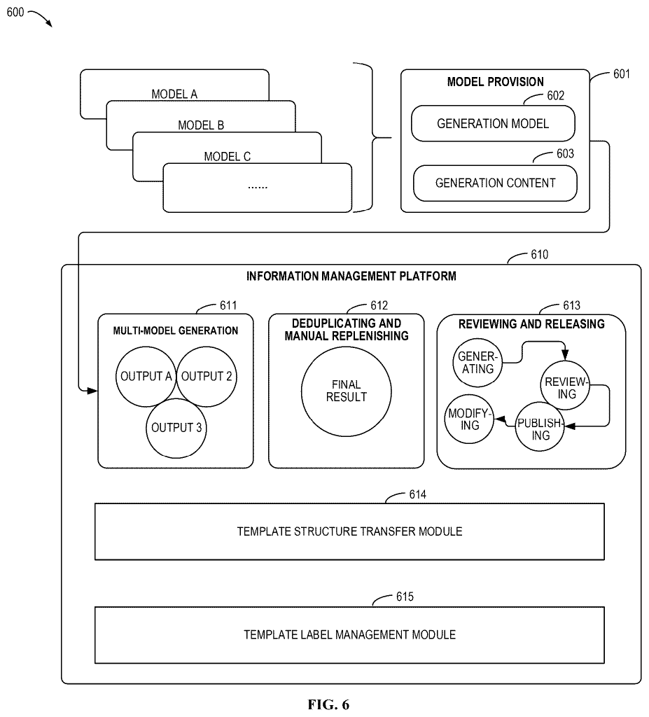

Referring to FIG. 6, FIG. 6 is a schematic diagram of an example 600 according to some embodiments of the present disclosure. The example 600 relates to the information management platform 610. The information management platform 610 may be deployed, for example, in the recommendation management system 150. The information management platform 610 comprises a multi-model generation module 611, a deduplicating and manual replenishing module 612, an reviewing and releasing module 613, a template structure transfer module 614, and a template label management module 615. The multi-model generation module 611 comprises a model providing module 601. The model provision module 601 may process the prompt input using a plurality of models (e.g., comprising model A, model B, model C, etc.) based on the indication for the generation model 602, and obtain the model generation content 603 from the plurality of models. The generation mode 602 may, for example, indicate a language of the generated content. For example, the generation mode 602 may indicate code of the generated machine language. The multi-model generation module 611 may determine a plurality of outputs of the plurality of models.

The deduplicating and manual replenishing module 612 may deduplicate the outputs of the plurality of models, and receive adjustments to the model output from the user. The deduplicating and manual replenishing module 612 may determine the final result based on the deduplicated, adjusted model output. The final result is the target service information entry requirement.

The reviewing and releasing module 613 may generate a service information entry page corresponding to the target service type based on the target service information entry requirement, and review the service information entry page. The reviewing and releasing module 613 may releasing the page that passes the review. The reviewing and releasing module 613 may further receive an adjustment performed by the user on the service information entry page, and update the service information entry page based on the adjusted service information entry page.

The template structure transfer module 614 may, for example, transfer the service information entry page to other platforms/systems, so that other platforms/systems may provide the service information entry page to the service provider 152. The template label management module 615 may manage the determined at least one service information entry page, which facilitates the user to modify, edit, etc. the service information entry page.

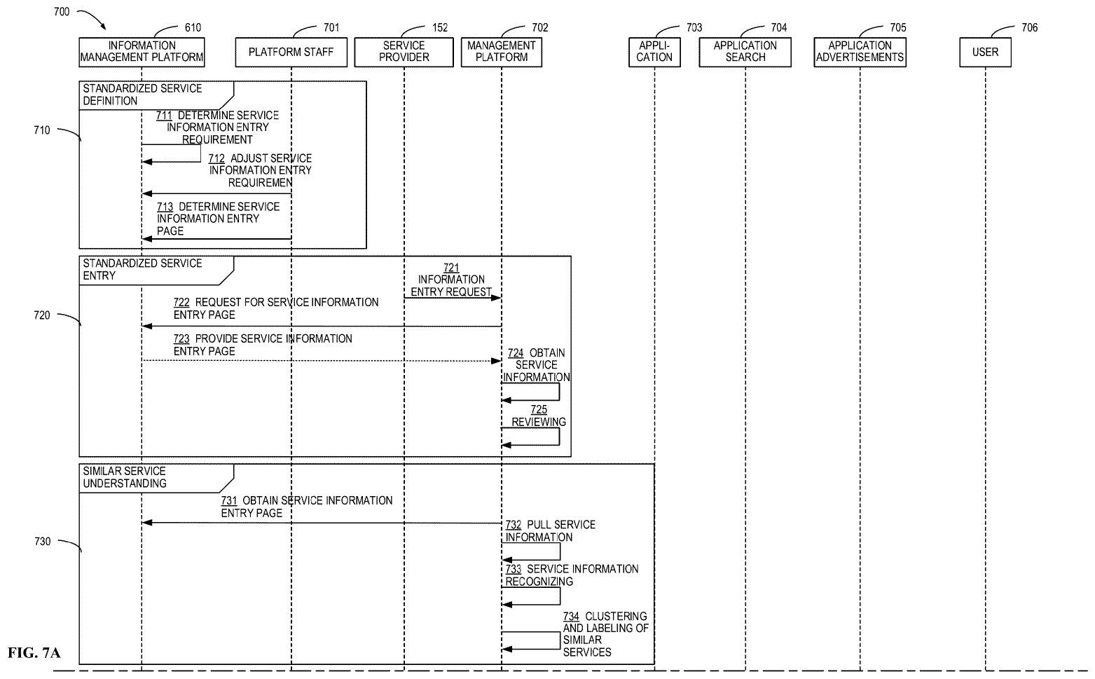

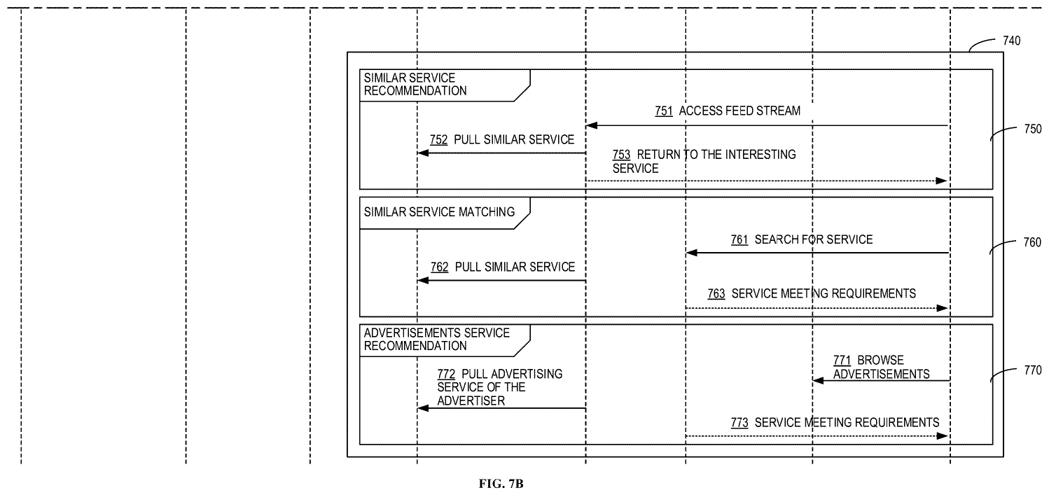

Referring to FIGS. 7A and 7B, illustrated is a schematic diagram of an example 700 of information interaction according to some embodiments of the present disclosure. Example 700 comprises four stages of standardized service definition 710, standardized service entry 720, similar service understanding 730, and application display 740. At the stage of the standardized service definition 710, the standardized service definitions of service type granularity need to be completed. This definition describes basic components of a service. At the stage of standardized service entry 720, there is a need to receive service information entered by service provider 152 that it can provide services. At the stage of the similar service understanding 730, the received service information is stored, and the service information is understood. Similar services may be clustered based on understanding results. At the stage of application display 740, a recommendation content item (e.g., an advertisement) matching the service information may be provided to the user in an application.

Example 700 relates to the information management platform 610, the platform staff 701, the service provider 152, the management platform 702, the application 703, the application search 704, the application advertisement 705, and the user 706. The information management platform 610 and the management platform 702 herein may be deployed, for example, in the recommendation management system 150.

At the stage of the standardized service definition 710, the information management platform 610 may determine (711) a service information entry requirement. The determination of the service information entry requirement may be implemented in accordance with the embodiments discussed above. In some embodiments, the platform staff 701 may adjust (712) the service information entry requirement determined by the information management platform 610, so that the information management platform 610 determines the adjusted service information entry requirement. The information management platform 610 may then determine (713) the service information entry page based on the adjusted service information entry requirement.

At the stage of standardized service entry 720, the management platform 702 may receive (721) an information entry request from service provider 152, and request (722) a service information entry page from information management platform 610 in response to receiving the information entry request. In response to the reception of the request, the information management platform 610 may provide (723) the service information entry page to the management platform 702. The management platform 702 may present the service information entry page, and obtain (724) the service information entered by the service provider 152 via the service information entry page. In some embodiments, the management platform 702 may also review (725) the service information to ensure compliance of the service information.

At the stage of similar service understanding 730, the management platform 702 may request (731) the service information entry page from information management platform 610. The management platform 702 may pull (732) service information from the service information entry page, and perform (733) service information recognition on the pulled service information. The management platform 702 may obtain a plurality of service information entered by the plurality of service providers 152. The management platform 702 may perform (734) similar service clustering and labeling on the obtained plurality of service information.

The stage of application display 740 may comprise similar service recommendation 750, similar service matching 760, and advertisement service recommendation 770. In the similar service recommendation 750, the user 706 may access (751) the information flow in the application 703. The application 703 may pull (752) the recommendation content item corresponding to the service similar to the content from the management platform 702 based on the content browsed by the user 706. The application 703 may return (753) to the user 706 the recommendation content item corresponding to the service it may be interested in.

In the similar service matching 760, the user 706 may search (761) the service with the application search 704. The application 703 may pull (762), from the management platform 702, the recommendation content item corresponding to a service that is similar to the service searched by user 706. The application 703 may return (763) the recommendation content item corresponding to the service meeting the requirement to the user 706 via the application search 704.

In some embodiments, in the advertisement service recommendation 770, the user 706 may browse (771) the advertisement via the application advertisement 705, which recommends the corresponding service. The application 703 may pull (772) a service recommendation from the management platform 702 that belongs to the same advertiser (e.g., the same service provider 152) with the advertisement browsed by the user. The application 703 may return (773) the recommendation content item corresponding to the service meeting the requirement to the user 706 via the application search 704.

In summary, according to the embodiments of the present disclosure, with the model capability, the service information structured definition of the industry may be implemented through a small amount of manpower, and the user experience and the service recommendation efficiency of the client are improved.

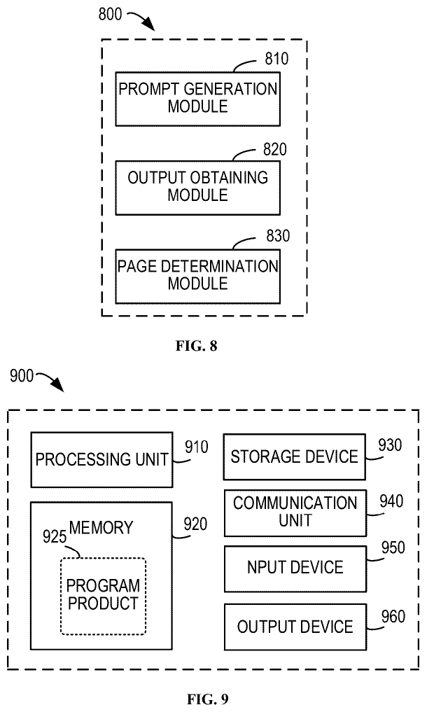

FIG. 8 illustrates a schematic structural block diagram of an apparatus 800 for information interaction according to some embodiments of the present disclosure. The apparatus 800 may be implemented or comprised in the recommendation management system 150. The various modules/components in the apparatus 800 may be implemented by hardware, software, firmware, or any combination thereof.

As shown, the apparatus 800 comprises a prompt generation module 810, configured to generate a first prompt input for each of the at least one machine learning model, the first prompt input is configured to guide the corresponding machine learning model to generate the service information entry requirement corresponding to the target service type. The apparatus 800 further comprises an output obtaining module 820 configured to obtain the output of the at least one machine learning model by providing the first prompt input to the corresponding machine learning model. The apparatus 800 further comprises a page determination module 830 configured to determine the service information entry page corresponding to the target service type based on the output of the at least one machine learning model, wherein the service information entry page at least indicates a plurality of information entry items.

In some embodiments, the output of the at least one machine learning model is represented in a natural language, and the page determining module 830 comprises: a first requirement determination module configured to determine a target service information entry requirement corresponding to the target service type based on the output of the at least one machine learning model; a code generation module configured to generate code corresponding to the machine language based on the target service information entry requirement; and a page generation module configured to generate the service information entry page corresponding to the target service type based on the code.

In some embodiments, the code generation module comprises: a second prompt generation module configured to generate a second prompt input for the at least one machine learning model based on the target service information entry requirement, wherein the second prompt input is configured to guide the at least one machine learning model to generate the code corresponding to the machine language based on the target service information entry requirement; and a code obtaining module configured to obtain the code output by the at least one machine learning model by providing the second prompt input to the at least one machine learning model.

In some embodiments, the output of the at least one machine learning model indicates at least one of: at least one information type corresponding to the target service type, at least one candidate information entry item of each information type, entry optionality of a respective candidate information entry item, an entry mode of a respective candidate information entry item.

In some embodiments, the prompt generation module 810 comprises: a template obtaining module configured to obtain the prompt template for each of the at least one machine learning model; and a first prompt generation module configured to fill the prompt template with an indication of the target service type to obtain the first prompt input.

In some embodiments, the page determining module 830 comprises: a presentation module configured to present the output of the at least one machine learning model to a user; a second request determination module configured to determine, based on a received adjustment of the output of the at least one machine learning model by the user, wherein the target service information entry requirement corresponds to the target service type; and a first page determination module configured to determine the service information entry page corresponding to the target service type based on the target service information entry requirement.

In some embodiments, the at least one machine learning model comprises a plurality of machine learning models, and the page determination module 830 comprises: a deduplication module configured to determine the target service information entry requirement corresponding to the target service type by deduplicating the outputs of the plurality of machine learning models; and a second page determination module configured to determine the service information entry page corresponding to the target service type based on the target service information entry requirement.

The units and/or modules comprised in the apparatus 800 may be implemented in various manners, comprising software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 800 may be implemented, at least in part, by one or more hardware logic components. By way of example and not limitation, exemplary types of hardware logic components that may be used comprise field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may comprise, for example, the recommendation management system 150 in FIG. 1.

FIG. 9 illustrates a block diagram of an electronic device 900 in which one or more embodiments of the present disclosure may be implemented. It should be understood that the electronic device 900 illustrated in FIG. 9 is merely illustrative and should not constitute any limitation on the functionality and scope of the embodiments described herein. The electronic device 900 shown in FIG. 9 may be used to implement the client device 130, or the content delivery platform 110, the recommendation conversion component 140, and/or the recommendation management system 150 (or various components therein). The electronic device 900 may comprise or be implemented as the device 800 of FIG. 8.

As shown in FIG. 9, the electronic device 900 is in the form of a general-purpose computing device. Components of the electronic device 900 may comprise, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to programs stored in the memory 920. In multiprocessor systems, multiple processing units execute computer-executable instructions in parallel to improve parallel processing capabilities of the electronic device 900.

The electronic device 900 typically comprises a plurality of computer storage media. Such media may be any available media accessible to the electronic device 900, comprising, but not limited to, volatile and non-volatile media, removable and non-removable media. The memory 920 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 930 may be a removable or non-removable medium, and may comprise a machine-readable medium, such as a flash drive, magnetic disk, or any other medium, which may be capable of storing information and/or data (e.g., training data for training) and may be accessed within electronic device 900.

The electronic device 900 may further comprise additional removable/non-removable, volatile/non-volatile storage media. Although not shown in FIG. 9, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 920 may comprise a computer program product 925 having one or more program modules configured to perform various methods or actions of various embodiments of the present disclosure.

The communication unit 940 is configured to communicate with another electronic device through a communication medium. Additionally, the functionality of components of the electronic device 900 may be implemented in a single computing cluster or multiple computing machines capable of communicating over a communication connection. Thus, the electronic device 900 may operate in a networked environment using logical connections with one or more other servers, network personal computers (PCs), or another network node.

The input device 950 may be one or more input devices, such as a mouse, a keyboard, a trackball, or the like. The output device 960 may be one or more output devices, such as a display, a speaker, a printer, or the like. The electronic device 900 may further communicate with one or more external devices (not shown), such as storage devices, display devices, through the communication unit 940 as needed, communicate with one or more devices that enable a user to interact with the electronic device 900, or communicate with any device (e.g., a network card, a modem, etc.) that enables the electronic device 900 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided. The computer program product is tangibly stored on a non-transitory computer-readable medium, and comprises computer-executable instructions that, when executed by a processor, implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner. Thus, the computer-readable medium storing instructions comprises an article of manufacture, which comprises instructions to implement aspects of the functions/acts specified in one or more blocks in the flowchart and/or block diagram.

The computer-readable program instructions may be loaded onto a computer, other programmable data processing apparatus, or other devices, such that a series of operational steps are performed on a computer, other programmable data processing apparatus, or other devices to produce a computer-implemented process. Thus, the instructions executed on a computer, other programmable data processing apparatus, or other devices implement the functions/acts specified in one or more blocks the flowchart and/or block diagram.

The flowchart and block diagrams in the drawings show architecture, functionality, and operation of possible implementations of systems, methods, and computer program products according to various implementations of the present disclosure. In this regard, each block in the flowchart or block diagram may represent a module, program segment, or portion of an instruction that comprises one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/we claim:

1. A method for information interaction, comprising:
generating a first prompt input for each of at least one machine learning model, the first prompt input being configured to guide a corresponding machine learning model to generate a service information entry requirement corresponding to a target service type;
obtaining at least one output of the at least one machine learning model by providing the first prompt input to the corresponding machine learning model; and
determining a service information entry page corresponding to the target service type based on the at least one output of the at least one machine learning model, the service information entry page at least indicating a plurality of information entry items.

2. The method of claim 1, wherein the at least one output of the at least one machine learning model is represented in a natural language, and determining the service information entry page corresponding to the target service type based on the at least one output of the at least one machine learning model comprises:
determining the target service information entry requirement corresponding to the target service type based on the at least one output of the at least one machine learning model;
generating code corresponding to a machine language based on the target service information entry requirement; and
generating the service information entry page corresponding to the target service type based on the code.

3. The method of claim 2, wherein generating the code corresponding to the machine language based on the target service information entry requirement comprises:
generating a second prompt input for the at least one machine learning model based on the target service information entry requirement, the second prompt input being configured to guide the at least one machine learning model to generate the code corresponding to the machine language based on the target service information entry requirement; and
obtaining code output by the at least one machine learning model, by providing the second prompt input to the at least one machine learning model.

4. The method of claim 1, wherein the at least one output of the at least one machine learning model indicates at least one of:
at least one information type corresponding to the target service type,
at least one candidate information entry item of each information type,
entry optionality of a respective candidate information entry item, or
an entry mode of a respective candidate information entry item.

5. The method of claim 1, wherein generating the first prompt input comprises:
obtaining a prompt template for each of the at least one machine learning model; and
filling the prompt template with an indication of the target service type to obtain the first prompt input.

6. The method of claim 1, wherein determining the service information entry page corresponding to the target service type based on the at least one output of the at least one machine learning model comprises:
presenting the at least one output of the at least one machine learning model to a user;
determining, based on a received adjustment of the at least one output of the at least one machine learning model by the user, the target service information entry requirement corresponding to the target service type; and
determining the service information entry page corresponding to the target service type based on the target service information entry requirement.

7. The method of claim 1, wherein the at least one machine learning model comprises a plurality of machine learning models, and wherein determining the service information entry page corresponding to the target service type comprises:
determining the target service information entry requirement corresponding to the target service type by deduplicating the outputs of the plurality of machine learning models; and
determining the service information entry page corresponding to the target service type based on the target service information entry requirement.

8. An electronic device, comprising:
at least one processor; and
at least one memory, coupled to the at least one processor and storing instructions for execution by the at least one processor, the instructions, when executed by the at least one processor, causing the electronic device to perform acts comprising:
generating a first prompt input for each of at least one machine learning model, the first prompt input being configured to guide a corresponding machine learning model to generate a service information entry requirement corresponding to a target service type;
obtaining at least one output of the at least one machine learning model by providing the first prompt input to the corresponding machine learning model; and
determining a service information entry page corresponding to the target service type based on the at least one output of the at least one machine learning model, the service information entry page at least indicating a plurality of information entry items.

9. The electronic device of claim 8, wherein the at least one output of the at least one machine learning model is represented in a natural language, and determining the service information entry page corresponding to the target service type based on the at least one output of the at least one machine learning model comprises:
determining the target service information entry requirement corresponding to the target service type based on the at least one output of the at least one machine learning model;
generating code corresponding to a machine language based on the target service information entry requirement; and
generating the service information entry page corresponding to the target service type based on the code.

10. The electronic device of claim 9, wherein generating the code corresponding to the machine language based on the target service information entry requirement comprises:
generating a second prompt input for the at least one machine learning model based on the target service information entry requirement, the second prompt input being configured to guide the at least one machine learning model to generate the code corresponding to the machine language based on the target service information entry requirement; and
obtaining code output by the at least one machine learning model, by providing the second prompt input to the at least one machine learning model.

11. The electronic device of claim 8, wherein the at least one output of the at least one machine learning model indicates at least one of:
at least one information type corresponding to the target service type,
at least one candidate information entry item of each information type,
entry optionality of a respective candidate information entry item, or
an entry mode of a respective candidate information entry item.

12. The electronic device of claim 8, wherein generating the first prompt input comprises:
obtaining a prompt template for each of the at least one machine learning model; and
filling the prompt template with an indication of the target service type to obtain the first prompt input.

13. The electronic device of claim 8, wherein determining the service information entry page corresponding to the target service type based on the at least one output of the at least one machine learning model comprises:
presenting the at least one output of the at least one machine learning model to a user;
determining, based on a received adjustment of the at least one output of the at least one machine learning model by the user, the target service information entry requirement corresponding to the target service type; and
determining the service information entry page corresponding to the target service type based on the target service information entry requirement.

14. The electronic device of claim 8, wherein the at least one machine learning model comprises a plurality of machine learning models, and wherein determining the service information entry page corresponding to the target service type comprises:
determining the target service information entry requirement corresponding to the target service type by deduplicating the outputs of the plurality of machine learning models; and
determining the service information entry page corresponding to the target service type based on the target service information entry requirement.

15. A non-transitory computer-readable storage medium, storing thereon a computer program executable by a processor to implement a method comprising:
generating a first prompt input for each of at least one machine learning model, the first prompt input being configured to guide a corresponding machine learning model to generate a service information entry requirement corresponding to a target service type;
obtaining at least one output of the at least one machine learning model by providing the first prompt input to the corresponding machine learning model; and
determining a service information entry page corresponding to the target service type based on the at least one output of the at least one machine learning model, the service information entry page at least indicating a plurality of information entry items.

16. The non-transitory computer-readable storage medium of claim 15, wherein the at least one output of the at least one machine learning model is represented in a natural language, and determining the service information entry page corresponding to the target service type based on the at least one output of the at least one machine learning model comprises:
determining the target service information entry requirement corresponding to the target service type based on the at least one output of the at least one machine learning model;
generating code corresponding to a machine language based on the target service information entry requirement; and
generating the service information entry page corresponding to the target service type based on the code.

17. The non-transitory computer-readable storage medium of claim 16, wherein generating the code corresponding to the machine language based on the target service information entry requirement comprises:
generating a second prompt input for the at least one machine learning model based on the target service information entry requirement, the second prompt input being configured to guide the at least one machine learning model to generate the code corresponding to the machine language based on the target service information entry requirement; and
obtaining code output by the at least one machine learning model, by providing the second prompt input to the at least one machine learning model.

18. The non-transitory computer-readable storage medium of claim 15, wherein the at least one output of the at least one machine learning model indicates at least one of:
at least one information type corresponding to the target service type,
at least one candidate information entry item of each information type,
entry optionality of a respective candidate information entry item, or
an entry mode of a respective candidate information entry item.

19. The non-transitory computer-readable storage medium of claim 15, wherein generating the first prompt input comprises:
obtaining a prompt template for each of the at least one machine learning model; and
filling the prompt template with an indication of the target service type to obtain the first prompt input.

20. The non-transitory computer-readable storage medium of claim 15, wherein determining the service information entry page corresponding to the target service type based on the at least one output of the at least one machine learning model comprises:
presenting the at least one output of the at least one machine learning model to a user;
determining, based on a received adjustment of the at least one output of the at least one machine learning model by the user, the target service information entry requirement corresponding to the target service type; and
determining the service information entry page corresponding to the target service type based on the target service information entry requirement.
